(19) United States
(12) Patent Application Publication
(10) Pub. No.: US 2014/0085813 A1
(43) Pub. Date: Mar. 27, 2014

(54) FILM OR COMPOSITE THAT INCLUDES A NANOMATERIAL

(71) Applicant: LIQUIDCOOL SOLUTIONS, Rochester, MN (US)

(72) Inventor: Salah S. Sedarous, Rochester, MN (US)

(73) Assignee: LIQUIDCOOL SOLUTIONS, Rochester, MN (US)

(21) Appl. No.: 14/028,721

(22) Filed: Sep. 17, 2013

Related U.S. Application Data
(60) Provisional application No. 61/706,192, filed on Sep. 27, 2012.

(51) Int. Cl. C09K 5/06; G06F 1/20; C09K 5/00

(52) U.S. Cl. CPC C09K 5/06; C09K 5/00; G06F 1/20; Y10S 977/833; B82Y 30/00
USPC 361/679.54; 252/74; 524/570; 524/404; 427/331; 977/833

(57) ABSTRACT

The present disclosure relates to a film or a composite that provides excellent heat removal capabilities and improved chemical stability and methods of forming the film and the composite. The film can be a layer of a nanomaterial. The composite can include a nanomaterial and a thermal interface material (TIM). The methods generally involve dispersing the nanomaterial in a carrier when forming the film or the composite.

### FIELD

This disclosure relates to a film that includes a nanomaterial and a composite that includes the nanomaterial and a thermal interface material (TIM). The film and composite have applications in a variety of high tech areas such as the thermal management and high flux cooling of electronics devices, such as CPUs in computers or servers, field-effect transistors, integrated circuits, printed circuit boards, three-dimensional integrated circuits, and optoelectronic devices, such as light-emitting diodes, and related electronics, opto-electronics, and photonic devices and circuits.

### BACKGROUND

The overall trend in electronics technology has been to continually decrease the chip size of semiconductors while continually increase the packaging density of electronics. At the same time, electronic devices have been designed to perform more functions and operate at higher speeds. This overall trend has led to a continued increase in the number of circuits within a given unit area. As a consequence, the power consumed by the devices has increased dramatically.

Most of the power consumed by the devices dissipates as heat. An increase in heat generation, coupled with an overall reduction in size of electronic devices, leads to an increase in the amount of heat generated per unit area (heat density). The increase of heat density requires an increase in rate at which heat is removed from the devices and circuits in order to protect them from exposure to excessive heat. Therefore, improvements in cooling the devices are desirable.

### SUMMARY

The present disclosure relates to a film or a composite that provides excellent heat removal capabilities and improved chemical stabilities and methods of forming the film and the composite. The film can be a layer of a nanomaterial. The composite can include a nanomaterial and a thermal interface material (TIM). The methods generally involve dispersing the nanomaterial in a carrier when forming the film or the composite. The application in which the film or the composite is used can be any application in which the film or the composite is suitable for use and that requires heat removal, including, but not limited to, uses in electronics, optoelectronic, photonic devices and integrated circuits.

In some embodiments, the nanomaterial used can be any nanomaterial that has a high thermal conductivity and is useful for heat removal. Examples of the nanomaterial that can be used include, but are not limited to, graphene nanoplatelets (xGnP), carbon nanotubes (CNT), and hexagonal-boron nitride (hex-BN). In some other examples, the nanomaterial used can be hydrophobic and/or have a flat symmetry.

In some embodiments, the thermal interface material (TIM) that can be used include any thermally conductive material that can be applied to increase thermal contact conductance across surfaces. Conventionally known TIMs that can be used include, but are not limited to, epoxies, greases, gels and phase-change materials. One specific example of the TIM that can be used, for example, by modifying with a nanomaterial, is Bergquist gap filler 3500S35.

In one embodiment, a method of forming the film includes mixing a nanomaterial with a carrier, dispersing the nanomaterial within the carrier so as to form a dispersion of nanomaterial, dispensing the dispersion of nanomaterial on a surface of a substrate and then substantially removing the carrier.

In another embodiment, a method of forming the composite includes mixing a nanomaterial with a carrier, dispersing the nanomaterial within the carrier so as to form a dispersion of the nanomaterial, and mixing the dispersion of the nanomaterial with a thermal interface material.

In yet another embodiment, the film or the composite is provided in a system that includes a heat sink and a computer processor unit (CPU). In this instance, the film or the composite is provided as a layer between the heat sink and the CPU.

### BRIEF DESCRIPTION OF DRAWINGS

FIG. 1 shows a system that includes a computer processor unit (CPU), a heat sink and a film or composite.

FIG. 2 shows an embodiment of a method of forming a film.

FIG. 3A shows a schematic drawing of a dispersion of a nanomaterial within a carrier.

FIG. 3B shows a schematic drawing of the dispersion shown in FIG. 3A dispensed on a surface of a substrate.

FIG. 4 shows an embodiment of a method of forming a composite.

FIG. 5 shows a photo of samples of Bergquist gap filler 3500S35 alone, and composites that include Bergquist gap filler 3500S35 and a nanomaterial. Specifically, the top left sample is Bergquist gap filler 3500S35 alone, the top right sample is a composite that includes Bergquist gap filler 3500S35 embedded with xGnP, the bottom left sample is Bergquist gap filler 3500S35 alone, and the bottom right sample is a composite that includes Bergquist gap filler 3500S35 embedded with hex-BN.

FIG. 6A shows a photo of Bergquist gap filler 3500S35 that has been subjected to a chemical stability test.

FIG. 6B shows a photo of a composite including Bergquist gap filler 3500S35 and a dispersed nanomaterial that has been subjected to a chemical stability test.

### DETAILED DESCRIPTION

A film or a composite that has excellent heat removal capabilities and superior chemical stability is described. Generally, the film or the composite is obtained by dispersing a nanomaterial in a carrier.

The term “nanomaterial” herein means a material with morphological features on a scale that is, for example, smaller than about 100 nm in at least one dimension, for example about 100 nm in at least one dimension. The nanomaterial can be in any shape or form that is suitable for use as a thermally conductive material.

In some examples, “dispersing the nanomaterial” means that the nanomaterial is dispersed in the carrier so that the nanomaterial is distributed homogenously in the carrier.

The nanomaterial used can have properties such as high thermal conductivity, hydrophobicity, and/or plane symmetry. The term “plane symmetry” means a flat, two-dimensional surface. Examples of nanomaterials that can be used include, but are not limited to, graphene nanoplatelets (xGnP), carbon nanotubes (CNT) and hexagonal-boron nitride (hex-BN). The nanomaterials can be used by themselves or in any combination thereof. For example, in one embodiment, graphene nanoplatelets and hexagonal-boron nitride can be used together.

The carrier that can be used to disperse the nanomaterial can be any medium that is suitable for dispersing a nanomaterial. In some instances, the carrier can be a liquid, for example, a liquid that is a hydrophobic medium. In some examples, the carrier is a dielectric liquid that has properties such as high dielectric strength, high thermal stability and chemical inertness against the construction materials used, non-flammability, low toxicity and good thermal conductivity. Examples of a dielectric liquid that can be used include, but are not limited to, transformer oil such as mineral oil, alkanes such as n-hexane and n-heptane, polyalkenes such as polyalphaolefin (PAO) and purified water.

In one embodiment, the film includes the nanomaterial and is generally formed by dispersing the nanomaterial in a carrier, and then substantially removing the carrier so as to form a layer in which the nanomaterial is in a dispersed state.

In some examples, the layer of nanomaterial can include a monolayer having a thickness of a stack of an allotrope of an element. In some instances, the nanomaterial includes a stack of an allotrope of carbon (graphene). In this instance, the thickness of a stack of graphene can be about 6 to about 8 nanometers. In some instances, the layer of nanomaterial can include multiple monolayers. In one implementation, the layer of nanomaterial includes 18 to 24 layers of singles sheets of graphene. The layer of nanomaterial can be measured using optical techniques such as Raman or mechanical techniques such as atomic force microscopy (AFM).

Without being bound to theory, dispersing the nanomaterial in the carrier can lead to a decrease in the thickness of the stack of an allotrope of an element. For instance, it is known that graphene nanoplatelets (xGnP) in a solid state include less than ten layers in each stack of graphene. Dispersing the nanomaterial can reduce the number of layers, and thereby enhance its thermal conductivity.

In another embodiment, the composite includes a nanomaterial and a thermal interface material (TIM). The term “thermal interface material” means a thermally conductive material which can be applied to increase thermal contact conductance between two surfaces in order to increase thermal transfer efficiency. In some examples, TIMs that can be used include a polymer matrix and a thermally conductive filler. In one instance, the TIMs used are those that are commonly used in electronic packages, and include several classes of materials such as epoxies, greases, gels and phase-change materials.

Examples of epoxies that can be used include metal-filled epoxies, which are highly conductive materials that thermally cure into highly cross-linked materials.

Examples of greases that can be used include thermal greases that have good wetting, ability to conform to the interfaces, no post-dispense processing and high bulk thermal conductivity.

Gels that can be used can include a silicone polymer such as vinyl-terminated silicone polymer, a cross-linker, and thermally conductive filler.

Phase-change materials (PCMs) that can be used are materials that undergo a transition from a solid to a liquid phase with the application of heat. One example of a phase-change material is solder.

In some examples, the TIM used can be Bergquist gap filler 3500S35 and/or thermal paste Silver-5.

In some instances, the composite is obtained by dispersing the nanomaterial in a carrier and then mixing the dispersed nanomaterial with the TIM. In some examples, the dispersed nanomaterial is included in an amount sufficient for increasing the thermal conductivity and/or lowering the surface contact resistance of the TIM as compared to that of where no dispersed nanomaterial is added to the TIM or as compared to that of where a corresponding nanomaterial that is dry is added to the TIM. In other examples, the nanomaterial is included in an amount sufficient for increasing the surface area of the TIM and/or the chemical stability as compared to those where no dispersed nanomaterial is added to the TIM or as compared to those where a corresponding nanomaterial that is dry is added to the TIM.

The term “surface contact resistance” herein means resistance of heat flow due to the contact between two surfaces. That is, actual contact between two surfaces occurs at the high points of each of the surfaces, leaving air-filled voids where the valleys align. The air voids resist the flow of heat and force more of the heat to flow through the contact points. This constriction resistance is referred to as the surface contact resistance and can be a factor at all contacting surfaces.

Generally, in order to lower surface contact resistance, it is better to use mechanically softer TIMs to allow closer contact between the TIM and the target interfaces, thus reducing the chances of nano- or micro-void formation. In some examples, the addition of the dispersed nanomaterial to the TIM can render the composite mechanically softer than that of where no dispersed nanomaterial is added to the TIM, thereby lowering the surface contact resistance.

In some instances, the amount of the nanomaterial included in the composite can be less than about 20% by weight based on the weight of the TIM. In some implementations, the amount of the nanomaterial is measured based on the dry weight of the nanomaterial.

In some instances, the amount of the TIM included in the composite can be about 0.1 to about 10% by weight based on the total weight of the composite. The ultimate optimum value can depend on the chemical and physical properties of the carrier and the nanomaterials used.

In some examples, the composite can further include a thermally conductive filler. The thermally conductive filler used can be any material that is suitable for use with TIMs, and can include, but is not limited to, metals and metal oxides such as silver, copper, nickel, platinum, gold, aluminium, titanium, aluminium oxide (Al₂O₃), beryllium oxide (BeO), magnesium oxide, zinc oxide and zirconium oxide. The thermally conductive filler can be in the form of particles such as powders or flakes, where the particles can have a nano size distribution.

In some instances, the amount of the thermally conductive filler that can be added to the composite is less than about 1% by weight based on the total weight of the composite, alternately about 1 to about 20% by weight based on the total weight of the composite.

As indicated above, one of the advantages of the disclosed film or composite is that the film or composite has superior chemical stability, and this property is particularly useful in systems where the film or composite is required to be in an environment where the film or composite is in direct contact with a dielectric fluid.

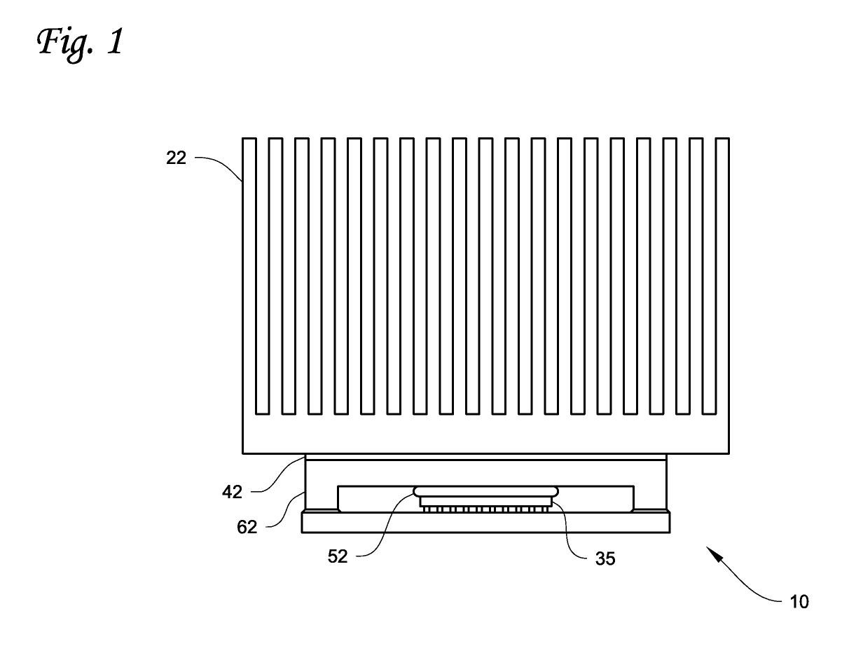

One embodiment of a system that includes the film or composite will now be described. Referring to FIG. 1, a system 10 includes a heat sink 22, a computer processor unit (CPU) 35 and a film or composite 42. The film or composite 42 is provided between the CPU 35 and the heat sink 22. In particular, the film or composite 42 is provided between the heat sink 22 and a cap 62, and a first TIM 52 is provided between the CPU 35 and the cap 62.

In the example shown in FIG. 1, the first TIM 52 and the cap 62 is provided between the film or composite 42 and the CPU 35. However, it is to be realized that the film or composite 42 can be placed anywhere between the CPU 35 and the heat sink 22 that is suitable for heat removal. In some examples, the system 10 does not include the first TIM 52 and/or the cap 62 (not shown). In other examples, the system includes a dielectric fluid (not shown) such that the film or composite 42 is in direct contact with the dielectric fluid.

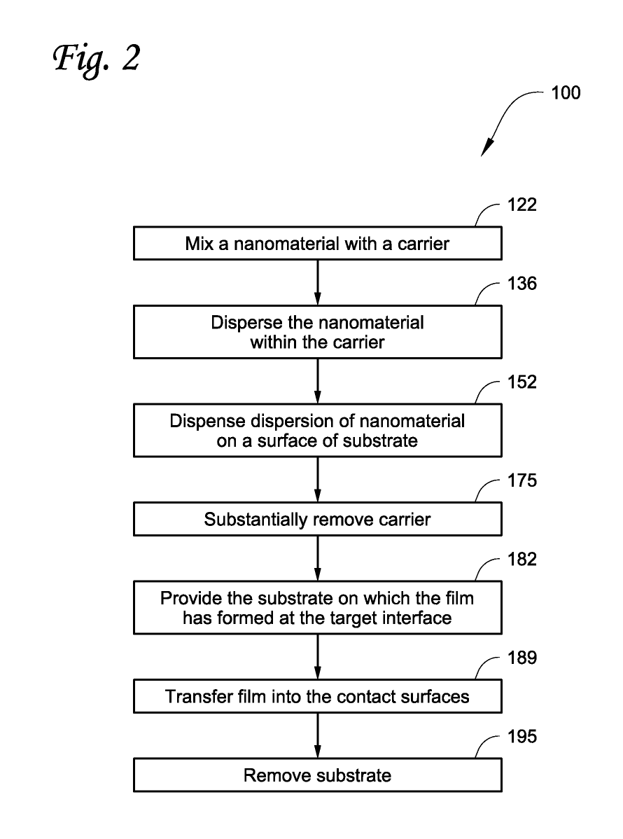

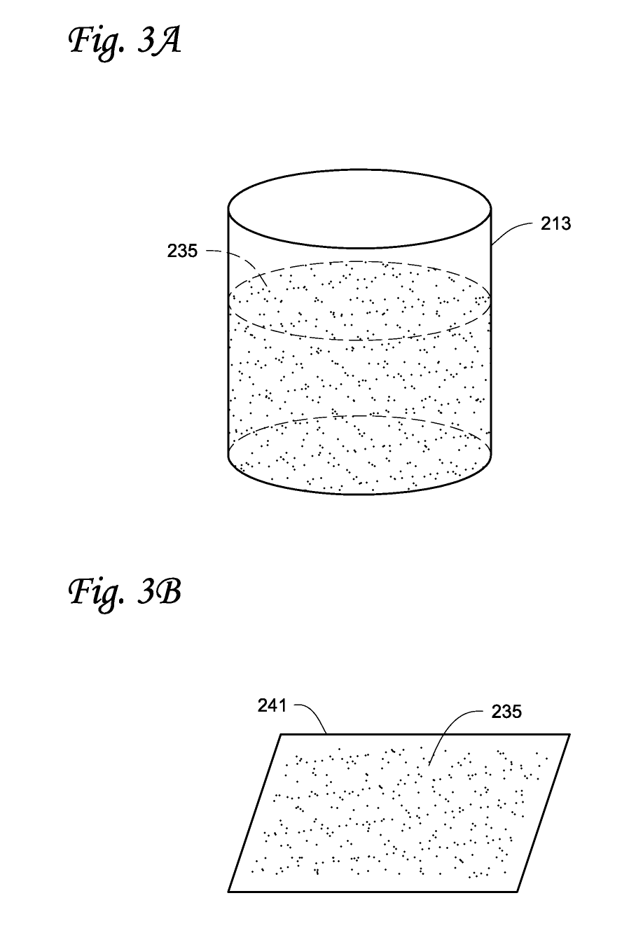

One embodiment of a method of preparing a film will now be described. Referring to FIG. 2, a method 100 includes mixing a nanomaterial with a carrier (step 122) so as to wet the nanomaterial and then dispersing the nanomaterial within the carrier (step 136) so as to form a dispersion of a nanomaterial within the carrier. In some examples, dispersing the nanomaterial includes breaking agglomerates of the nanomaterial by applying a high shear force. FIG. 3A shows a schematic drawing of a container 213 holding a dispersion of a nanomaterial within a carrier 235. In one example, the nanomaterial is dispersed in the carrier by physical and/or chemical treatments so that the nanomaterial is in a homogenous state within the carrier.

Examples of physical treatments for dispersing the nanomaterial include, but are not limited to, mechanical agitation such as sonication or milling. An example of a chemical treatment for dispersing the nanomaterial includes an addition of a dispersing agent. The dispersing agent utilized can be, but is not limited to, antioxidant agents, friction reducing agents and detergents. In some examples, the dispersing agent can be used to stabilize the dispersed stated of the nanomaterial in the carrier.

In the instance where the nanomaterial is dispersed by sonication, the nanomaterial can be exfoliated by sonication using a tip or a bath sonicator for a time sufficient to disperse the nanomaterial in the carrier to a homogenous state. In some examples, the nanomaterial can be exfoliated for about one to three hours.

After dispersing the nanomaterial in the carrier, the dispersion is then dispensed on a surface of a substrate (step 152). FIG. 3B shows a schematic drawing of the dispersion 235 that is dispensed on a substrate 241. The substrate used can be any substrate that is suitable for use in applications where leaving lint or fibers on a surface would be undesirable. In one example, the substrate used is a cleaning tissue commonly used in laboratories such as KimWipes.

After the dispersion is dispensed on the substrate, the carrier is substantially removed (step 175) so as to form a film. In some examples, the film that is formed is a layer of nanomaterial. In some instances, the film is a monolayer having a thickness of a stack of an allotrope of an element.

The term “substantially removed” means that about 90 to about 100% of the carrier is removed. In some instances, the technique that is used to substantially remove the carrier depends on the type of carrier that is used. Examples of techniques that can be used to substantially remove the carrier include, but are not limited to, use of an adsorbent and evaporation. Examples of an adsorbent that can be used to remove the carrier include, but are not limited to, adsorbent pads ad absorbent mats.

In some examples, a thin layered film that has formed on the substrate in step 175 can be then transported to a target interface. In one instance, after step 175, the film is transported to the target interface by providing the substrate on which the film has formed at the target interface (step 182). The film is then transferred into the contact surfaces (step 189), and then the substrate is removed (step 195).

In some examples, the target interface can be between the CPU 35 and the heat sink 22 in the system 10, and the substrate used can be a KimWipe. In this instance, the film is transported to the target interface by placing the KimWipe on which the film has formed between the CPU 35 and the heat sink 22. The film is then transferred into the contact surfaces, and then the KimWipe is removed. In some examples, transferring the film involves mechanically squeezing the film between the heat sink 22 and the CPU 35, thereby leaving the film on the contact surfaces.

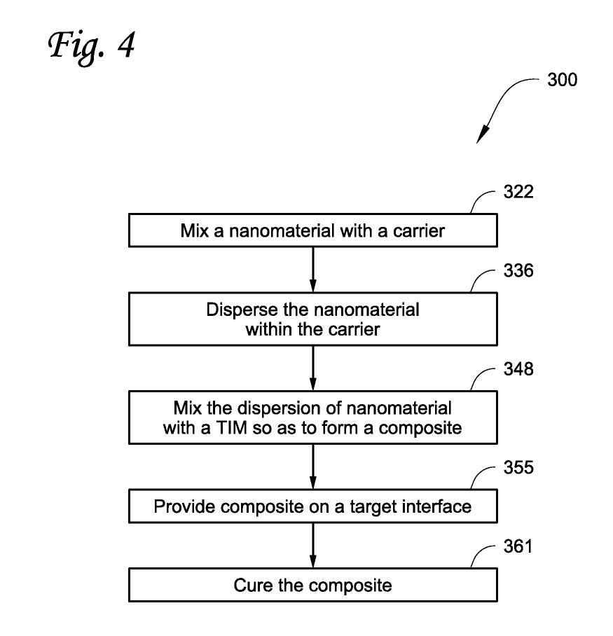

One embodiment of a method of preparing a composite will now be described. Referring to FIG. 4, a method 300 includes mixing a nanomaterial with a carrier (step 322) and then dispersing the nanomaterial within the carrier (step 336). In one example, the nanomaterial is dispersed within the carrier by physical and/or chemical treatments so that the nanomaterial is in a homogenous state within the carrier. The physical and/or chemical treatments utilized can be the same as those described above.

After dispersing the nanomaterial within the carrier, the dispersion is then mixed with a TIM so as to form a composite (step 348). In some examples, the composite that is formed then can be provided at a target interface (step 355). The composite then can be cured (step 361).

In some examples, the target interface can be between the CPU 35 and the heat sink 22 in the system 10. In this instance, the composite can be provided at a target interface by forming a layer of the composite between the CPU 35 and the heat sink 22, and then curing the layer of the composite.

### EXAMPLES

### Example 1

### A Thin Film of Graphene Nano-Platelets in Polyalphaolefin (PAO)

The graphene nano-platelets used in this example are xGnP® brand graphene nanoplatelets, and have the following characteristics:

The xGnP® brand graphene nanoplatelets have a very thin but wide aspect ratio. The aspect ratios for this material range from 500 to 1000. Each particle consists of several sheets of graphene with an overall thickness ranging from an average of about 5 nm to about 15 nm, depending on grade. Particle diameters can range from sub-micron to 50+ microns. The thermal conductivity of xGnP is between 2000 to 5000 w/m K.

The xGnP® graphene nanoplatelets used have the following bulk characteristics as provided by the manufacturer:
Physical appearance: a fine black or grey granular material.
Bulk density: varies with average particle size from 0.03 to 0.15 g/cc.
Oxygen content: varies with particle size, but normally less than 1 percent.
Miscellaneous impurities: less than 0.5 wt %.
Each individual particle normally has an irregular shape and a clean surface.
The individual particles have a clean surface consisting of SP2 carbon and are hydrophobic by nature. Naturally occurring functional groups on the edges of the particles include compounds like ether, hydroxyl and carboxyl groups.

To prepare the xGnP film, a dry sample of xGnP was added to PAO, and the resulting mixture was exfoliated in PAO by sonication for a few hours using a tip or bath sonicator. A small amount of the resulting dispersion was then dispensed onto a KimWipe (KimTech science brand), and was allowed to dry by placing the KimWipe into contact with an absorbing paper. After drying for a few days, the KimWipe with the graphene film was cut into a square sheet that is slightly larger than the contact area between the processor and the heat sink. The square sheet was then placed between a CPU and a heat sink to transfer the xGnP film from the KimWipe into the contact surfaces. The KimWipe was then removed.

### Example 2

### A Composite Including xGnP and Bergquist Gap Filler 3500S35

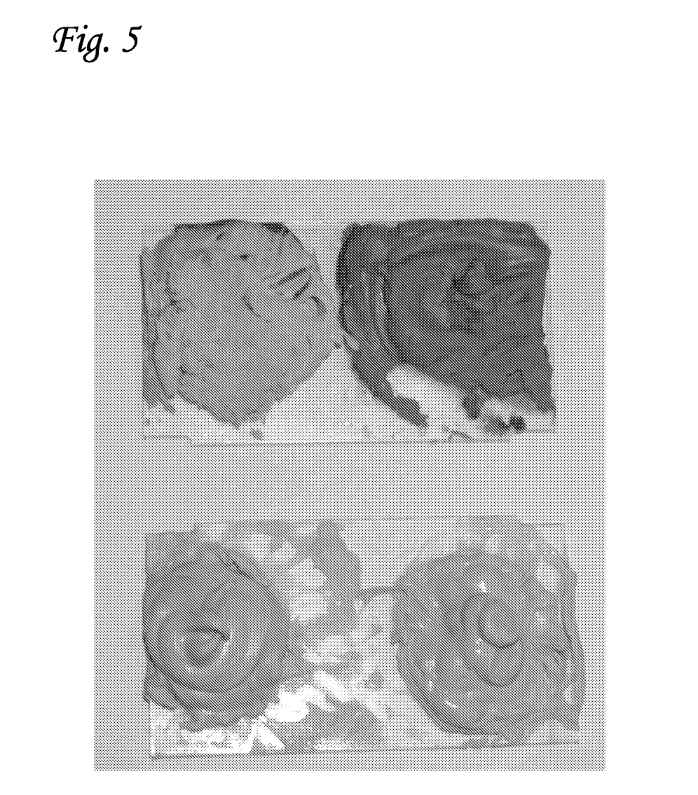

A dry sample of xGnP described in Example 1 was added to PAO. xGnP was then exfoliated by sonication using a bath sonicator for a few hours. A small amount of the exfoliated xGnP/PAO was dispensed into Berquist gap filler 3500S35 so as to form a composite. Berquist gap filler 3500S35 has a thickness of about 100 microns and a thermal conductivity of 3.6 w/m K before mixing. A sample of the resulting composite is shown in the top right of the photo in FIG. 5. The composite was then placed between a CPU and a heat sink and allowed to cure overnight.

### Example 3

### A Thin Film of Carbon Nanotubes (CNT) in Polyalphaolefin (PAO)

Same as Example 1, except that CNT instead of xGnP was used. The CNT used has a thickness of about 100 microns and has a thermal conductivity of about 4000 w/m K.

### Example 4

### A Composite Including CNT and Bergquist Gap Filler 3500S35

Same as Example 2, except that CNT instead of xGnP was used. The CNT used was the same as that of Example 3.

### Example 5

### A Thin Film of Hexagonal-Boron Nitride (hex-BN) in Polyalphaolefin (PAO)

Same as Example 1, except that hex-BN instead of xGnP was used. The hex-BN used has a thickness of less than or equal to about 100 microns and a thermal conductivity of about 200 to 500 w/m K.

### Example 6

### A Composite Including Hexagonal-Boron Nitride (hex-BN) and Bergquist Gap Filler 3500S35

Same as Example 2, except that hex-BN instead of xGnP is used. The hex-BN that was used was the same as that of Example 5. A sample of the resulting composite including hex-BN and Berqguist is shown in the bottom right of the photo in FIG. 5.

### Thermal Characteristics of Film and Composite

In order to test the thermal characteristics of the film and the composite, a standard torture test can be used. The test can involve the use of the system as shown in FIG. 1. For the CPU, Intel Core 2 Extreme series of quad core processors which are rated for thermal design power (TDP) of 130 W or more can be used. The processor can run at a standard clock speed of 3.0 GHz with a cache size of 12 MB L2, and native FSB of 1,333 MHz. A standard torture test utilizing Prime95 can be used to stress the processor and to raise the surface temperature of the CPU which is in contact with the film or composite. The other side of the film or composite can be in contact with an Intel FCLGA4-S heat sink. The temperature rises of components of the computer can be recorded before and during the torture test and the highest changes in the temperature of the CPU in contact with different materials can be used to characterize thermal properties of the given film or composite.

### Chemical Stability Test in PAO

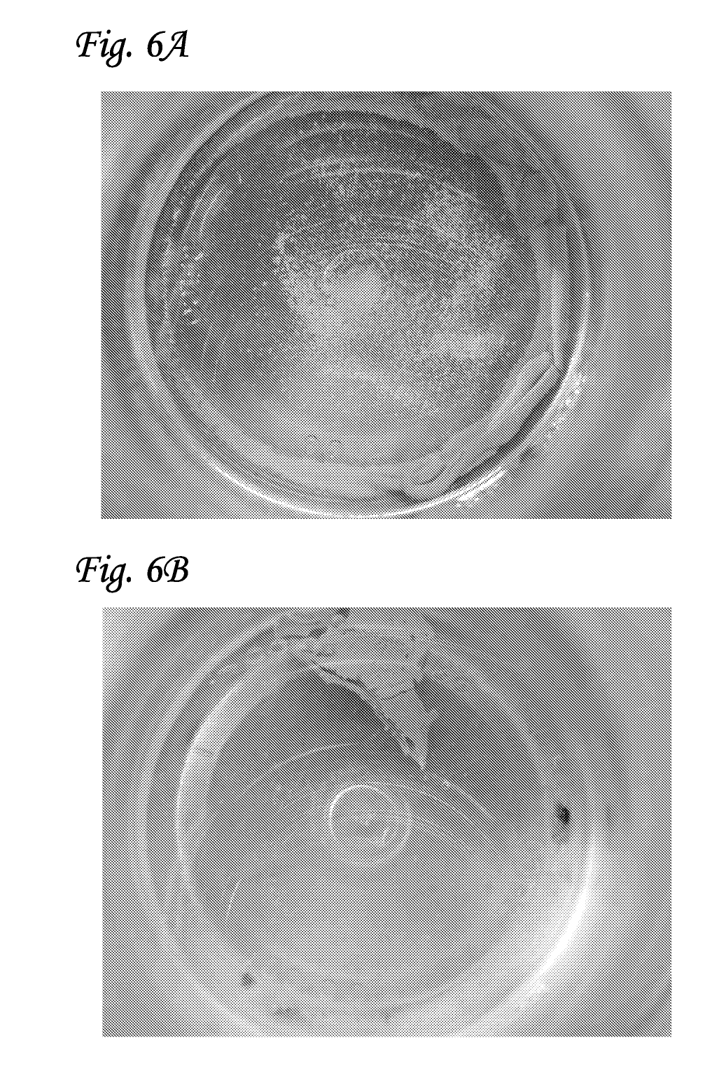

Samples of Bergquist gap filler 3500S35 alone and a composite including Bergquist gap filler 3500S35 mixed with a dispersed xGnP were prepared, placed in PAO, heated in a hot bath of 90° C. for a few weeks, and stored at room temperature for eleven months in PAO. FIGS. 6A (Bergquist gap filler 3500S35 alone) and 6B (composite including Bergquist gap filler 3500S35 mixed with a dispersed xGnP) show the results of the chemical stability test in PAO. The Bergquist gap filler 3500S35 alone immediately started to disintegrate into its original chemical composition of white and blue materials. FIG. 6A shows the breakdown of the initial mix, the granule nature of the surface, and the presence of white suspension at the bottom of the container. On the other hand, the composite sample remained intact as shown in FIG. 6B. The coolant was clear from any floating debris and the composite surface was smooth and intact.

The embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein.

What is claimed is:

1. A film comprising a layer of a nanomaterial, wherein the nanomaterial is in a dispersed state within the layer.

2. The film of claim 1, wherein the nanomaterial is at least one selected from the group consisting of graphene nanoplatelets (xGnP), carbon nanotubes (CNT) and hexagonal-boron nitride (hex-BN).

3. A film that is formed by
mixing a nanomaterial with a carrier;
dispersing the nanomaterial within the carrier so as to form a dispersion of nanomaterial;
dispensing the dispersion of nanomaterial on a surface of a substrate; and
substantially removing the carrier so as to form the film.

4. The film of claim 3, wherein the nanomaterial is at least one selected from the group consisting of graphene nanoplatelets (xGnP), carbon nanotubes (CNT) and hexagonal-boron nitride (hex-BN).

5. The film of claim 3, wherein the carrier is a liquid that is a hydrophobic medium.

6. The film of claim 3, wherein the carrier is a dielectric liquid.

7. The film of claim 6, wherein the dielectric liquid is at least one selected from the group consisting of a transformer oil, an alkane, a polyalkene and purified water.

8. The film of claim 7, wherein the polyalkene is polyalphaolefin (PAO).

9. A composite comprising a nanomaterial and a thermal interface material, wherein the composite is formed by
mixing the nanomaterial with a carrier;
dispersing the nanomaterial within the carrier so as to form a dispersion of the nanomaterial; and
mixing the dispersion of the nanomaterial with the thermal interface material so as to form the composite.

10. The composite of claim 9, wherein the nanomaterial is at least one selected from the group consisting of graphene nanoplatelets (xGnP), carbon nanotubes (CNT) and hexagonal-boron nitride (hex-BN).

11. The composite of claim 9, wherein the carrier is a liquid that is a hydrophobic medium.

12. The composite of claim 9, wherein the carrier is a dielectric liquid.

13. The composite of claim 12, wherein the dielectric liquid is at least one selected from the group consisting of a transformer oil, an alkane, a polyalkene and purified water.

14. The composite of claim 13, wherein the polyalkene is polyalphaolefin (PAO).

15. The composite of claim 9, wherein the thermal interface material is at least one selected from the group consisting of an epoxy, a thermal grease and a phase-change material.

16. The composite of claim 15, wherein the phase-change material is solder.

17. The composite of claim 9, wherein the thermal interface material is at least one selected from the group consisting of Bergquist gap filler 3500S35 and thermal paste Silver-5.

18. A method of forming a film, comprising:
mixing a nanomaterial with a carrier;
dispersing the nanomaterial within the carrier so as to form a dispersion of nanomaterial;
dispensing the dispersion of nanomaterial on a surface of a substrate; and
substantially removing the carrier.

19. The method of claim 18, wherein the nanomaterial is at least one selected from the group consisting of graphene nanoplatelets (xGnP), carbon nanotubes (CNT) and hexagonal-boron nitride (hex-BN).

20. The method of claim 18, wherein the carrier is a liquid that is a hydrophobic medium.

21. The method of claim 18, wherein the carrier is a dielectric liquid.

22. The method of claim 21, wherein the dielectric liquid is at least one selected from the group consisting of a transformer oil, an alkane, a polyalkene and purified water.

23. The method of claim 22, wherein the polyalkene is polyalphaolefin (PAO).

24. A method of forming a composite, comprising:
mixing a nanomaterial with a carrier;
dispersing the nanomaterial within the carrier so as to form a dispersion of the nanomaterial; and
mixing the dispersion of the nanomaterial with a thermal interface material.

25. The method of claim 24, wherein the nanomaterial is at least one selected from the group consisting of graphene nanoplatelets (xGnP), carbon nanotubes (CNT) and hexagonal-boron nitride (hex-BN).

26. The method of claim 24, wherein the carrier is a liquid that is a hydrophobic medium.

27. The method of claim 24, wherein the carrier is a dielectric liquid.

28. The method of claim 27, wherein the dielectric liquid is at least one selected from the group consisting of transformer oil, an alkane, a polyalkene and purified water.

29. The method of claim 28, wherein the polyalkene is polyalphaolefin (PAO).

30. The method of claim 24, wherein the thermal interface material is at least one selected from the group consisting of an epoxy, a thermal grease and a phase-change material.

31. The method of claim 30, wherein the phase-change material is solder.

32. The method of claim 24, wherein the thermal interface material is at least one selected from the group consisting of Bergquist gap filler 3500S35 and thermal paste Silver-5.

33. A system comprising:
a computer processor unit;
a heat sink; and
the film of claim 1 that is provided between the computer processor unit and the heat sink.

34. A system comprising:
a computer processor unit;
a heat sink; and
the film of claim 3 that is provided between the computer processor unit and the heat sink.

35. A system comprising:
a computer processor unit;
a heat sink; and
the composite of claim 9 that is provided between the computer processor unit and the heat sink.
